(19) United States
(12) Patent Application Publication
(10) Pub. No.: US 2007/0192735 A1
(43) Pub. Date: Aug. 16, 2007

(54) Mobile communication terminal and method therefore

(76) Inventors: Julia Lehto, Tampere (FI); Heikki J. Poikela, Tampere (FI); Jari Valimaa, Lempaala (FI); Antti A. Leinonen, Tampere (FI); Erik Simko, Tampere (FI); Waqas Muhammad, Tampere (FI)

Correspondence Address: PERMAN & GREEN, 425 POST ROAD, FAIRFIELD, CT, 06824, US

(21) Appl. No.: 11/441,274

(22) Filed: May 25, 2006

Related U.S. Application Data
(60) Provisional application No. 60/773,791, filed on Feb. 15, 2006.

(51) Int. Cl. G06F 3/048

(52) U.S. Cl. 715/810; 715/824

(57) ABSTRACT

Inactive services may be selected from a menu and the selection will prompt an opportunity for the user to subscribe and activate the attribute with a minimum of effort and interruption.

### CROSS-REFERENCE TO RELATED APPLICATION(S)

This application claims the benefit of U.S. Provisional Application No. 60/773,791 filed Feb. 15, 2006 which is incorporated by reference herein in its entirety.

### FIELD OF INVENTION

The disclosed embodiments relate to the field of mobile communications. In particular, the disclosed embodiments relate to methods and systems for presenting selections on a display through which a user can select unsubscribed attributes and thereby revise the user's service provider subscription.

### TECHNICAL BACKGROUND

A mobile communications device basically comprises a set of buttons and a joystick, a screen, by which the user is given feedback from the mobile communications device, and electronic circuitry providing the communication application by which the mobile communications device is able to communicate with other communications devices via a base station system.

A mobile communications device of this basic kind is well-known in the art and there is no need for any detailed description.

As soon as the mobile communications device is turned on, the operating system of the mobile communications device starts running. The operating system handles e.g. the interaction between the display unit, the input unit, and the communications unit. The operating system also handles other kinds of applications, such as a contact management application, a calendar application, a settings application for setting the behaviour of the phone and its operating system, a web application, etc.

The operating system is adapted to, in a desktop view, show the different applications on the display unit in the form of so-called icons. The icons are basically graphic representations of start buttons. The user navigates, using the joystick or the buttons, between the icons on the desktop. Usually, one of the icons is always highlighted or otherwise indicated as selected. When the user presses the arrow buttons or actuates the joystick, the icon being located in the intended direction, will be highlighted.

When the joystick or a physical selection button is pressed down, the application associated with the highlighted icon is activated. The window of the activated application is shown on the screen of the mobile communications device. Generally, when an icon of the list is selected the associated application is activated.

In some instances, the applications, features, items, attributes, parameters, presented as icons on a display (collectively referred to herein as attributes), depend on the user's subscription with the service provider. In certain instances unsubscribed attributes are presented on a display in gray and cannot be activated without a change in subscription through a registration process at the service provider. It would be desirable and convenient to provide a system that permits the selection of an attribute from a display and to provide activation of the attribute with a corresponding adjustment of the user's subscription.

Communication modes that are derivative of instant messaging services have expanded and now include: chat capability, voice capability, text messaging, email, and other modes. The displays relating to these applications are an example of an application in which subscription adjustments from the display would be particularly advantageous.

As part of instant messaging, “presence data” is made available indicating a user's availability for participation in a communication. Presence data indicates that a person is “logged in” “idle” “logged out” and other information. A user's profile may also be presented as part of presence data. In order for two participants to communicate, each must subscribe to the others presence information. In the current form instant messaging now includes a wide variety of modes of communication, sometimes referred to as “presence attributes”. In order to subscribe to a mode, a user generally must select the mode through contact with a service provider. In particular it may be advantageous to select specific attributes with respect to a particular contact from a display in which the presence data is shown, as opposed to a re-registration process which makes the selection for all contacts and requires an interruption in usage. In accordance with common practice, the presence data may be presented on a “contact card” style display.

### SUMMARY

The disclosed embodiments are directed to a method in a mobile communications device and by a mobile communications device.

In accordance with an aspect of the invention a method is described for use in a mobile communications device having a display unit forming part of a user interface. In a navigation mode, an image comprising at least one application menu is displayed, said application menu displaying icons representing attributes that may or may not be executable under a user's subscription with a service provider. Icons that are selectable are differentiated in some manner, for example bold black, while inactive attributes are gray. An unsubscribed or inactive attribute may be selected by the user by navigation through the displayed menu. Upon such selection, the attribute is activated and the user is prompted to subscribe to the attribute. A positive response to the prompt will cause a message to be sent to the service provider updating the user's subscription and activating the selected attribute, which becomes immediately available for use.

In another aspect of the method of the invention, an instant messaging type of application menu is displayed which allows the user to navigate to a contact presence screen. Contact presence information is displayed for a particular contact, which indicates the various attributes of communications available, both subscribed/active and unsubscribed/inactive, with the subscribed and unsubscribed attributes differentiated for the user. When an inactive attribute is selected by the user by navigation through the displayed contact presence display, the user is prompted to subscribe to the attribute, if desired to activate. A positive response to the prompt will cause a message to be sent to the service provider updating the user's subscription and activating the selected attribute with respect to the contact whose presence information is displayed.

In another aspect of the invention a mobile communications device having a control unit, a display unit and an input unit, displays a series of application menus that may be selected by the user. The display unit displays, in a selected navigation mode, an image comprising a menu for a selected application. The application menu image displays icons representing attributes that may or may not be executable under a user's subscription with a service provider. Icons that are selectable are differentiated in some manner, for example bold black, while inactive attributes are gray. The control unit allows the selection of an inactive attribute by the user entering the selection through the input unit. Upon the selection of an inactive attribute, the control unit prompts the user, on the display, to subscribe to the attribute, if desired to activate. The user is allowed to enter a positive response to the prompt through the input unit. Upon a positive response, the control unit will send a message to the service provider updating the user's subscription and activating the selected attribute with respect to the application in which the user is currently navigating.

In another aspect of the invention a mobile communications device having a control unit, a display unit and an input unit is provided with a software module that causes the control unit to display a series of application menus that may be selected by the user. The software module causes the display unit to display, in a selected navigation mode, an image comprising a menu for a selected application. As directed by the software module, the application menu displays icons representing attributes that may or may not be executable under a user's subscription with a service provider. The software module causes the display to present the icons that are selectable in a differentiated manner, for example bold black, while unsubscribed attributes are gray. The software module causes the control unit to allow the selection of an unsubscribed attribute. Upon the selection of an unsubscribed attribute, the software module causes the control unit to prompt the user, on the display, to subscribe to the attribute, if desired to activate. The user is allowed to enter a positive response to the prompt through the input unit, which will cause a message to be sent to the service provider updating the user's subscription and activating the selected attribute with respect to the application in which the user is currently navigating.

In another aspect of the invention, the application menu, selected by the user through the use of an input unit of the communications device, is for an instant messaging type of application menu. This type of menu allows the user to navigate to a contact presence screen. The control unit displays contact presence information for a particular contact, which indicates the various attributes of communications available, both subscribed and unsubscribed, with the subscribed and unsubscribed attributes differentiated for the user. When an unsubscribed attribute is selected by the user by navigation through the displayed contact presence display, the control unit prompts the user to subscribe to the attribute, if desired to activate. Upon the entry of a positive response to the prompt, the control unit will cause a message to be sent to the service provider updating the user's subscription and activating the selected attribute with respect to the contact whose presence information is displayed.

### BRIEF DESCRIPTION OF THE DRAWINGS

The invention will by way of example be described in more detail with reference to the appended schematic drawings, which shows a presently preferred embodiment of the invention.

FIG. 1 shows the basic components of a mobile communications device and system;

FIG. 2 shows a mobile communication device;

FIGS. 3a and 3b show menu images in the display when an application is selected by the user; and

FIGS. 4a and 4b shows the menu image in the display when an instant messaging type application is selected.

### DETAILED DESCRIPTION OF PREFERRED EMBODIMENTS

A mobile communication device 100, for example a combination cellular telephone incorporating features of the present invention is illustrated in the figures. Although the present invention will be described with reference to the embodiments shown in the drawings, it should be understood that the present invention may have many alternate forms. In addition, any suitable size, shape or type of elements or materials could be used.

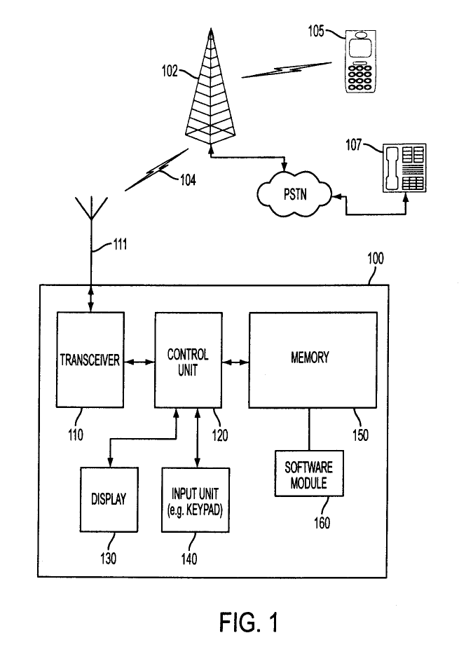

FIG. 1 is a schematic block diagram of a mobile telecommunication terminal 100 according to a preferred embodiment of the present invention. A transceiver 110 is used for communicating with a base station 102 via an antenna 111. The base station 102 is in communication with other mobile telecommunication terminals 105 via a mobile communications network, and stationary terminals 107 via e.g. a public switched telephone network (PSTN). The terminal 105 and network are generally adapted to support IP traffic, for example, WLAN, BT, IP-Pass-through and others.

Within mobile communication device 100, a control unit 120 is coupled to the transceiver 110. The control unit 120 may comprise signal processing circuitry in order to process e.g. voice data and message data (e.g. SMS or MMS) from a user of the mobile telecommunication terminal 100 and provide the transceiver 110 with the processed data for transmission to the base station 102. Likewise, the control unit 120 may comprise signal processing circuitry for processing data received from the other telecommunication terminals 105, 107 in order to provide the user of the mobile telecommunication terminal 100 with e.g. audio, image, video or message data. Alternatively (not shown) some or all of the signal processing functionality may be provided by specialized circuitry in the mobile telecommunication terminal 100.

The control unit 120 is coupled to a display 130 for providing a user of the mobile telecommunication terminal 100 with visual data regarding e.g. a specific call in progress, telecommunication numbers stored in the mobile telecommunication terminal 100, signal strength of the wireless communication link 104, messages received from other mobile telecommunication terminals, etc.

The control unit 120 is moreover coupled to an input unit 140, which may be in the form of a keyboard/keypad; an on-screen touch-sensitive keyboard; a navigation wheel or joystick for scrolling and selecting items, digits and/or characters shown on the display 120; etc.

A memory 150 is connected to the control unit 120. The memory 150 may be a single memory or many different memories implemented on different chips, alone or together with other electronic circuitry, by means of different technologies (such as RAM, ROM, EPROM, EEPROM, Flash, etc) which all are accessible by the control unit 120.

A mobile communications device of this basic kind is well-known in the art and there is no need for any further detailed description of the basic features of the mobile communications device.

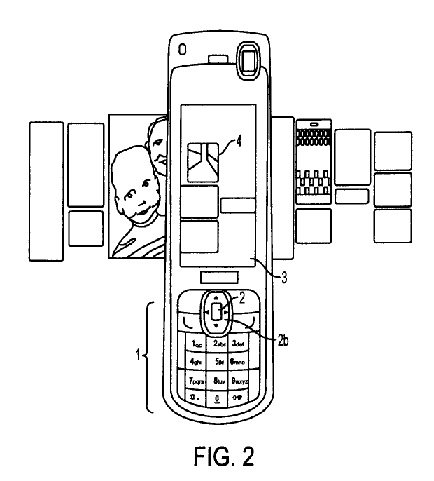

FIG. 2 shows a mobile communications device comprising a set of buttons 1 and a joystick 2, a screen 3.

As soon as the mobile communications device is turned on, an operating system of the mobile communications device starts running. The operating system handles e.g. the interaction between the display unit 3, the input unit 1, 2, and the communications unit.

The operating system is adapted to also handle other kinds of applications, such as a contact management application, a calendar application, a settings application for setting the behaviour of the phone and its operating system, a web application, instant messaging applications, etc, when they are activated.

The operating system is adapted to, in a desktop view (not shown), display the different available applications on the display unit 3 in the form of icons 4. The icons 4 are basically graphic representations of imaginary start buttons. The user navigates, using the keypad 1, amongst the icons 4 on the desktop to select an application.

Generally when an icon is selected, the associated application is activated. The window of the activated application is shown on the screen of the mobile communications device and may be used. In some applications, however, some applications, services, and their particular items, features, attributes, parameters, etc. (referred to collectively as attributes) may not be accessible, except by subscription prior to activation. Subscriptions are generally obtained through interaction with a service provider when a service is purchased and the mobile communication device is set up. A subscription may generally be upgraded by further registration with service provider. This is a cumbersome process which is inconvenient to pursue. Unsubscribed attributes are generally displayed as part of a menu in a diminished emphasis form, for example gray as opposed to bold black. Selection of an icon representing unsubscribed attribute will not generally be allowed.

In the system of this application, unsubscribed services may be selected from a menu and the selection will prompt an opportunity for the user to subscribe and activate the attribute with a minimum of effort and interruption.

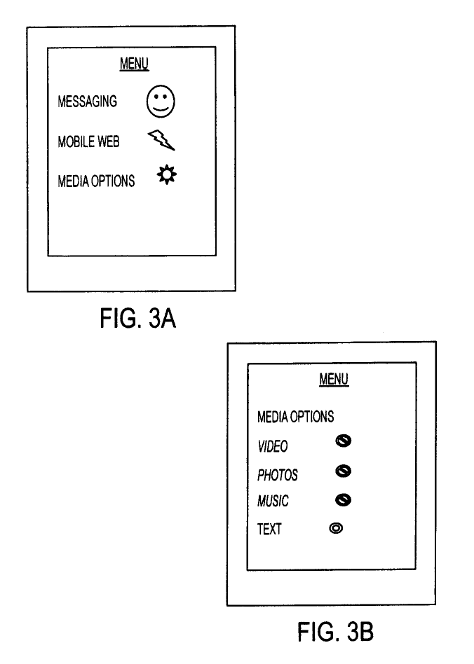

According to this invention, a mobile communications device as shown in FIGS. 1 and 2 has a control unit 120, a display unit 130 (screen 3 in FIG. 2) and an input unit 140. The control unit 130 initially presents a series of display images on screen 3 that represent application menus that may be selected by the user. The display unit 140 displays, in a selected navigation mode, an image comprising a menu for a selected application. As shown in FIG. 3a, a selected application menu image presents icons 4 representing attributes for selection. For the purpose of illustration, the user has selected highlighted icon for “media options” and navigates to the “media options” menu as shown in FIG. 3b. The menu of FIG. 3b presents icons, that may or may not be executable under a user's subscription with a service provider. Icons that are selectable are differentiated in some manner, for example bold black, while unsubscribed or inactive attributes are gray, i.e. “VIDEO, PHOTOS, MUSIC”. The control unit 140, under the operating software of this invention, allows the selection of an inactive attribute by the user entering the selection through the input unit 140. Upon the selection of an inactive attribute, for example MUSIC, the control unit prompts the user, on the display, to subscribe to the attribute, if desired to activate. This may be presented as a simple question, such as “SUBSCRIBE MUSIC” with answer option yes or no. The user is allowed to enter a positive or negative response to the prompt through the input unit 140. Upon a positive response, the control unit will send a message to the service provider updating the user's subscription and activating the selected attribute with respect to the application in which the user is currently navigating. Such messages could be delayed until the end of a session, so as to allow the inclusion of additional changes and updates that may be requested by the user. In this manner a single request can be sent to the service provider. In an alternate embodiment, the selection of the unsubscribed feature may automatically initiate the subscription update without the need for further input from the user. This would be accomplished in the background without interruption of the user's activity.

In an alternative embodiment, when the user subscribes to a new feature/attribute, instructions are sent to the service provider to send a notification every time the value of an unsubscribed attribute changes. The user receives and processes the notifications after each change and therefore is shown the correct active attributes according to the current subscription. In this manner the user is assured that the subscribed attributes shown are up-to-date.

In this manner a particular application, feature, attribute, etc. may be added to a subscription via a short cut that avoids the interruption of contact with a service provider which might otherwise require accessing an account services web site or the like. The selected attribute becomes immediately available, while the subscription change is processed.

The short cut is accomplished by the installation of a software module 160 that may be part of the operation software for the control unit 140 and stored in memory 150. An algorithm in software module 160 is executed upon the positive response to the prompt that is activated when an unsubscribed attribute is selected. The algorithm causes the mobile phone to send a message that relays the subscriber's identity and the decision to upgrade a subscription in a particular way. The service provider would likely confirm the upgrade by an email or other type of message.

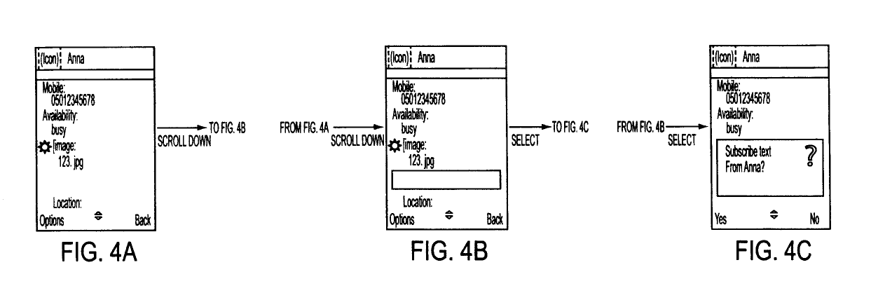

In an alternative embodiment, an instant messaging type of application menu is displayed, which allows the user to navigate to a contact presence screen, as shown in FIGS. 4a-4c. Contact presence information is displayed for a particular contact, which indicates the various attributes of communications available, both active and inactive, with the active and inactive attributes differentiated for the user. When an inactive attribute is selected by the user by navigation through the displayed contact presence display, the user is prompted to subscribe to the attribute, if desired to activate. A positive response to the prompt will cause a message to be sent to the service provider updating the user's subscription and activating the selected attribute with respect to the contact whose presence information is displayed. In alternate embodiment the activation and update may be accomplished automatically upon the selection of the inactive attribute.

In one embodiment, the user may also select a subscribed/active attribute and obtain a prompt by which the attribute may be inactivated with respect to the particular application or with regard to the contact whose presence information is displayed. This could be presented as an option that may be selected from an available submenu. The message sent to the service provider would reflect the user's desire to revise his subscription accordingly.

It should be understood that the above description is only illustrative of the invention. Various alternatives and modifications can be devised by those skilled in the art with out departing from the invention. Accordingly, the present invention is intended to embrace all such alternatives, modifications and variances which fall with the scope of the appended claims.

What is claimed is:

1. In a mobile communications device, a method for activating attributes comprising:
displaying at least one navigable menu, said menu displaying icons representing at least one attribute that is inactive under a user's subscription with a service provider;
sensing the selection of an inactive attribute; and
activating the selected attribute for execution by the user.

2. The method according to claim 1 further comprising:
sending a message to the service provider to revise the user's subscription to include the selected attribute.

3. The method according to claim 1 further comprising:
prompting the user upon the selection of an unsubscribed attribute to indicate if a revision of the user's subscription is desired, and sending said message upon a positive response to the prompt.

4. The method according to claim 1 wherein icons are presented representing both active attributes and inactive attributes and the active attributes are visually differentiated from the inactive attributes.

5. The method according to claim 1 wherein the menu displayed is an application menu for an instant messaging type of application, which allows the user to navigate to a contact presence screen and further comprising:
displaying on the contact presence screen contact presence information for a particular contact and the
various communication attributes available, including both active and inactive attributes;
sensing the selection of an inactive attribute; and
activating the selected attribute with respect to the contact whose presence information is displayed.

6. The method according to claim 5 further comprising:
sending a message to the service provider to revise the user's subscription to include the selected attribute with respect to the displayed contact presence.

7. A mobile communication device comprising:
a control unit, a display unit and an input unit, wherein the control unit presents on the display unit at least one menu containing icons that may be selected by the user, said icons representing at least one attribute that is inactive under a user's subscription with a service provider; and
wherein the input unit is adapted to permit the user to select an inactive attribute and upon a selection by the user the control unit is constructed to activate the selected attribute for execution by the user.

8. A device according to claim 7 wherein the control unit is further constructed to send a message to the service provider to revise the user's subscription to include the selected attribute.

9. The device according to claim 7 wherein the control unit is constructed to prompt the user, upon the selection of an inactive attribute, to indicate if a revision of the user's subscription is desired, and sending instructions to the service provider upon a positive response to the prompt to update the user's subscription.

10. The device according to claim 7 wherein icons are presented representing both active attributes and inactive attributes and the active attributes are visually differentiated from the inactive attributes.

11. The device according to claim 7, wherein the menu displayed is an application menu for an instant messaging type of application, which allows the user to navigate to a contact presence screen and further wherein the display unit presents, on the contact presence screen, contact presence information for a particular contact and the various communication attributes available, including both active and inactive attributes, and further wherein the user input permits the selection of an inactive attribute and further wherein the control unit senses the selection of an inactive attribute, and activates the selected attribute with respect to the contact whose presence information is displayed.

12. The device according to claim 11 wherein the control unit is further constructed to send a message to the service provider to revise the user's subscription to include the selected attribute.

13. A program product for use in a mobile communication device having a processor, said program product comprising:
processor readable program code for displaying an image presenting at least one navigable menu, said menu displaying icons representing at least one attribute that is inactive under a user's subscription with a service provider;
processor readable program code for sensing the selection of an inactive attribute; and
processor readable program code for activating the selected attribute for execution by the user.

14. The program product according to claim 13 further comprising processor readable program code for sending a message to the service provider to revise the user's subscription to include the selected attribute.

15. The program product according to claim 13 further comprising:
processor readable program code for prompting the user upon the selection of an inactive attribute to indicate if a revision of the user's subscription is desired, and sending instructions to the service provider to update the user's subscription upon a positive response to the prompt.

16. The program product according to claim 13 wherein the processor readable program code causes icons to be presented representing both active attributes and inactive attributes and wherein the active attributes are visually differentiated from the inactive attributes.

17. The program product according to claim 13 wherein the menu displayed is an application menu for an instant messaging type of application, which allows the user to navigate to a contact presence screen and further comprising:
processor readable program code for presenting, on the contact presence screen, contact presence information for a particular contact and the various attributes available, including both active and inactive;
processor readable program code for selecting an inactive attribute;
processor readable program code for sensing the selection of an inactive attribute; and
processor readable program code for activating the selected attribute for execution by the user.

18. The program product according to claim 17 further comprising:
processor readable program code for prompting the user to subscribe to the selected attribute; and
processor readable program code for, upon a positive response to the prompt, sending a message to the service provider updating the user's subscription and activating the selected attribute with respect to the contact whose presence information is displayed.
